(19) United States
(12) Patent Application Publication
(10) Pub. No.: US 2025/0315492 A1
(43) Pub. Date: Oct. 9, 2025

(54) ARTIFICIAL INTELLIGENCE CHATBOT

(71) Applicant: Honeywell International Inc., Charlotte, NC (US)

(72) Inventors: Ajay Rama Iyer, Bengaluru (IN); Aman Rai, Varanasi (IN); Banuprakash Balakrishna, Udupi (IN); Deepika Sandeep, Bangalore (IN); Devanshu Dugar, Kolkata (IN); Renil Austin Mendez, Kerala (IN); Shriram Sankaran, Bangalore (IN); Souvik Sardar, West Bengal (IN)

(21) Appl. No.: 19/170,300

(22) Filed: Apr. 4, 2025

Related U.S. Application Data
(60) Provisional application No. 63/575,452, filed on Apr. 5, 2024.

(51) Int. Cl. G06F 16/9538

(52) U.S. Cl. CPC G06F 16/9538

(57) ABSTRACT

Methods and systems for interacting with users via a chatbot. A natural language query is received and processed by submitting a search query to a search engine. The search engine identifies relevant information including textual information and images for formulating a response. The identified information and query are submitted to a Large Language Model which generates a response displayed via the chatbot. The response may include textual information and relevant images. The system can extract text from images of documents and convert textual information into numerical vector representations for processing. Selectable options based on clustered relevant information can be provided to users for query refinement when appropriate. The chatbot interface enables natural language interactions while leveraging search capabilities and Artificial Intelligence to provide informative and helpful responses with both text and visual elements.

### RELATED APPLICATIONS

This application claims the benefit of U.S. Provisional Application No. 63/575,452 filed Apr. 5, 2024, which application is incorporated by reference herein.

### TECHNICAL FIELD

The present disclosure relates generally to chatbots, and more particularly to chatbots for assisting personnel in handling technical challenges and/or managing assets of a facility.

### BACKGROUND

Facilities can include a large number of complex assets that must be installed, maintained and managed over time. This can present significant technical challenges for responsible personnel, especially for novice personnel that are not yet well versed in each of the assets and/or interactions of the assets at the facility. What would be desirable is a chatbot that can assist personnel in handling technical challenges and/or managing assets of a facility by, for example, providing quick and accurate real-time guidance for design, installation, operations, maintenance, asset lifecycle and inventory control. This may help improve productivity, operation, and maintenance of the facility, and possibly extend the lifespan of the assets of the facility.

### SUMMARY

The present disclosure relates generally to chatbots, and more particularly to chatbots for assisting personnel in handling technical challenges and/or managing assets of a facility. An example may be found in a method for interacting with a user via a chatbot. The illustrative method includes receiving a natural language query via the chatbot. The natural language query is processed and a corresponding search query is generated and submitted to a search engine. The search engine identifies relevant information for use in formulating a response to the natural language query including identifying relevant textual information and one or more relevant images or links to one or more relevant images. The identified relevant information along with the natural language query is then submitted to a Large Language Model. The Large Language Model generates the response to the natural language query based at least in part on the natural language query and the identified relevant information that was submitted to the Large Language Model. The response is displayed via the chatbot, wherein the response includes textual information and one or more relevant images or links to one or more relevant images.

Another example may be found in a system for interacting with a user via a chatbot. The illustrative system includes a chatbot user interface for receiving a natural language query from a user, a search engine, a Large Language Model, and a controller that is operatively coupled to the chatbot user interface, the search engine and the Large Language Model. The controller is configured to process the natural language query to formulate a corresponding search query and to submit the corresponding search query to the search engine, wherein the search engine identifies relevant information for use in formulating a response to the natural language query. The controller is configured to submit the identified relevant information along with the natural language query to the Large Language Model. The Large Language Model generates the response to the natural language query based at least in part on the natural language query and the identified relevant information that was submitted to the Large Language Model. The controller is configured to display the response to the user via the chatbot user interface.

Another example may be found in a method for interacting with a user via a chatbot. The illustrative method includes receiving a natural language query via the chatbot. The natural language query is processed and a corresponding search query is submitted to a search engine, wherein the search engine identifies relevant information for use in formulating a response to the natural language query. Two or more selectable options are provided via the chatbot that are based at least in part on the identified relevant information. A selection of one of the two or more selectable options is received via the chatbot. The natural language query and at least some of the identified relevant information that is relevant to the selected one of the two or more selectable options and/or the selected one of the two or more selectable options are submitted to a Large Language Model. The Large Language Model generates the response to the natural language query based at least in part on the at least some of the identified relevant information that is relevant to the selected one of the two or more selectable options and/or the selected one of the two or more selectable options that were submitted to the Large Language Model. The response is displayed via the chatbot.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system;

FIG. 2 is a schematic block diagram showing an illustrative architecture;

FIG. 3 is a schematic block diagram showing an illustrative architecture;

FIGS. 4A and 4B are flow diagrams that together show an illustrative method for interacting with a user via a chatbot;

FIG. 5 is a flow diagram showing an illustrative method for interacting with a user via a chatbot;

FIG. 6 is a flow diagram showing an illustrative method; and

FIGS. 7 through 12 are illustrative screen captures showing interactions between a user and a chatbot.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

In some cases, processes such as manual access, labor project estimation, data gathering, design, installation, commissioning, operations, maintenance, and tech support may be automated and streamlined using generative AI chatbots for handling technical challenges and managing assets of a facility. This solution cases and expedites processes at each stage by automating knowledge extraction from several data sources like product technical documentation (such as installation guides, troubleshooting manuals, etc.), real-time operational data, databases containing customer queries and corresponding resolution, etc., providing quick and accurate real-time guidance for design, installation, operations, maintenance, asset lifecycle and inventory control to improve productivity, operation, and/or maintenance of the system, and possibly extending the lifespan of the assets of the system.

In some cases, data/information from different sources may serve as the knowledge base for domain adaptation of Large Language Models (LLMs) to specific use cases/domains. LLM are generally pre-trained on data from the Internet, but are not trained on particular product, project, or operation specific information. In some cases, the knowledge base for customizing the LLM to specific use cases/domains may continuously evolve and expand as operational data and/or other information becomes available. Such a dynamic generative AI powered chatbot may provide many benefits over traditional chatbots including leveraging semantic processing of generative AI models like GPT-4 for real-time guidance, ensuring it can handle complex queries and provide instant, contextually relevant responses. It offers actionable solutions and recommendations in real time, bridging the gap between prediction and problem-solving. Another benefit is an enhanced user experience by integrating image/video retrieval with textual guidance, thus enriching the responses with visual information. The image retrieval capability of this solution allows incorporation of images/video and/or links to images/video into the chatbot's responses, thereby providing visual cues and further information to operators and technicians. In some cases, several “options” can be provided by the chatbot in response to a user inquiry. The user can select one of the “options”. Once an “option” is selected, relevant answers/information to the selected option can be provided via the chatbot. This may be particularly useful when a user query has some ambiguity as to the intent of the query. The options that are identified and displayed via the chatbot allow the user to quickly resolve the ambiguity and get to desired information quickly. In some cases, another option such as “other” may be provided, which is selected when the identified “options” are not considered particular relevant to the user. In some cases, when the “other” option is selected by the user via the chatbot, the user is encouraged to add/modify/update the user's original query.

In some cases, using generative AI addresses inefficiencies of manual methods, addresses skill gap issues, and offers real-time guidance and predictive insights using dynamic sources of knowledge. The integration of an image retrieval process elevates its capabilities, making it a comprehensive and invaluable tool for operators and technicians in various industries. Identifying and presenting options to the user in response to a query allows the user to quickly resolve any ambiguity and get to desired information quickly. Generative AI, powered by for example GPT-4, brings the ability to understand complex natural language queries and generate relevant responses. It infuses the solution with the capacity to interpret the context of user queries, retrieve relevant information, and generate accurate responses. This transformative capability, sometimes combined with cloud-based methodologies, propels this solution to the forefront of technical issue resolution and asset management, with efficiency, agility, and effectiveness.

In some cases, Large Language Models (LLMs) like GPT-4 trained on extensive datasets from the Internet may possess a remarkable ability to comprehend and generate human-like text. However, customization is crucial to tailor these models for specific needs/use cases/domains. One such specific use case is technical issue resolution and asset management, particular for a particular industry/domain. By providing relevant context specific information for the desired specific need/use case/domain, the LLMs may be used to understand domain-specific language, terminologies, and problem-solving nuances. This customization of the LLM empowers the LLM to produce more accurate and contextually fitting responses, effectively bridging the gap between general language understanding (such as GPT-4) and domain-specific expertise. The present disclosure harnesses the immense power of LLMs while refining their capabilities to serve specialized requirements, resulting in a highly effective and domain-adapted solution.

In some cases, integrating generative AI technology, particularly GPT-4, enables understanding and generating contextually relevant responses. In some embodiments, the combination of embedding models, Azure Cognitive Search, Langchain orchestration, and GPT-4 interaction may create a robust ecosystem which offers real-time responses, predictive insights, and an evolving database of solutions. The AI-driven cloud-based methodology may create an agile and efficient ecosystem for technical issue resolution and asset management.

In some cases, an innovative image retrieval process transforms the way in which technical issue resolution and asset management are handled. This image retrieval feature, which may involve retrieving relevant images and/or videos, may bridge the gap between textual guidance and visual information, which may significantly enhance the depth and breadth of knowledge accessible to operators and technicians in real or near real time. For example, by converting technical document PDF pages into image files and linking them to Azure blob storage, a seamless connection between text and visuals may be created. When users interact with the chatbot, their queries trigger a search in the image text that has been added to the knowledge base. The knowledge base may not only house the image text but also corresponding image URLs to images that contain the associated image text. The system may intelligently identify the image text that is most closely aligned with the desired response generated by the large language model, but also the corresponding image URLs. This integration may empower operators by providing them with not just textual information generated by the generative AI but also visual resources (e.g. corresponding image URLs or links) conveying further relevant information via the chatbot, which may enhance efficient problem-solving and informed decision-making.

In some cases, the interactive chatbot offers instant responses, 24/7 availability, with the goal of reducing inspection time and human errors. In some cases, several “options” can be provided by the chatbot in response to a user inquiry. The user can select one of the “options”. Once an “option” is selected, relevant answers/information to the selected option can be provided via the chatbot. In some cases, users are presented with predefined options that corresponding with tailored fixes for common issues. In other cases, when a user query has some ambiguity as to the intent of the query, options are identified and displayed via the chatbot that correspond to different possible user intents, allow the user to select the desired option to quickly resolve the ambiguity and get to desired information quickly. In some cases, another option such as “other” may be provided, which may be selected when the identified “options” are not considered particular relevant to the user. When the “other” option is selected by the user via the chatbot, the user may be encouraged to add/modify/update the user's original query. Such a chatbot may result in efficient issue resolution, minimizing downtime and maximizing user satisfaction.

In some cases, data sources may be collected, including for example, technical documents pertaining to building products, a datasets contains details such as site details, assets on site, a site model that relates the assets at the site, real time and historical operating data, and historical customer issues (e.g. tickets) and resolution. The technical documents can contain a spectrum of valuable resources such as datasheets, manuals, installation guides, and operational guides. This rich data repository may form the foundation for the AI-driven chatbot solution.

In some cases, a pre-processing step may be initiated. This pre-processing may involve segmenting the text data into smaller, logically cohesive portions, ensuring the preservation of semantic relevance. This segmentation strategy may be activated when a new heading or paragraph surfaces in a document while extracting text data from the document. The rationale behind this approach is to optimize answer retrieval efficiency. By focusing on subsets of documents that encapsulate context, as opposed to combing through the entire document content, the system may streamline the search for answers to particular queries.

In some cases, embeddings may be generated. Embedding models, employed with proficiency, may transform the textual data into numerical vector representations. These vectors encapsulate the contextual essence of the content, capturing its meaning and nuances. The transformation equips the AI system with the capability to perform similarity searches effectively, enabling it to provide tailored solutions to queries. The text-embedding-ada-002 model from OpenAI may be used to transform textual data into numerical vector representations, however it is contemplated that any other suitable embedding algorithms may be used. Examples of other embedding algorithms include Word2Vec, which was developed by Google. Word2Vec is a widely used technique for learning word embeddings from large corpora of text data. Another example is GloVe (Global Vectors for Word Representation), developed by Stanford NLP Group. GloVe is another popular method for learning word embeddings by factorizing the co-occurrence matrix of words in a corpus. Another example is BERT (Bidirectional Encoder Representations from Transformers), developed by Google. BERT is a powerful pre-trained language model that produces context-aware word embeddings by training on large corpora of text data using the Transformer architecture. Another example is Sentence Transformers, developed by UKPLab, Sentence Transformers provides pre-trained models that generate sentence embeddings using methods such as BERT, RoBERTa, and DistilBERT. Sentence Transformers enable semantic similarity computation and text classification tasks at the sentence level. Another example is T5 (Text-To-Text Transfer Transformer), developed by Google. T5 is a versatile pre-trained language model that frames all NLP tasks as text-to-text tasks, enabling it to handle a wide range of tasks with a unified architecture.

In some cases, an index may be created in Azure Cognitive Search. The vector representations find their place within an intelligently designed search index. In this embodiment, a goal is to establish an Azure Cognitive Search index that stores, for example, document embeddings along with corresponding metadata containing the document source and title. This vector database serves as a dynamic repository that enhances search accuracy, and speeds up the retrieval process which can be important in a chatbot application. The index creation process may leverage Azure Cognitive Search's capabilities to optimize the organization of vector representations, paving the way for efficient search and retrieval.

In some cases, a Langchain Model may be set up. Langchain is a library designed to help in interacting with Large Language Models. It simplifies many of the routine tasks associated with working with LLMs, such as extracting text from documents or indexing them in a vector database. In some embodiments, a Langchain model is used as an orchestrator within the architecture, and stands as a bridge between the user interface and the AI components. The Langchain model takes in user queries, interacts with the Azure Cognitive Search engine for document search and retrieval, and eventually interfaces that information with a Large Language Models (e.g. GPT-4) for response generation.

In some cases, prompt engineering not only optimizes the format of AI-generated responses but also facilitates operators to ask more refined and effective queries. By carefully crafting prompts, operators can elicit responses that are structured in a manner that aligns with their understanding and preferences. Complex technical information can be distilled into clear, step-by-step instructions that operators can easily comprehend and implement. Additionally, prompt engineering empowers operators to enhance their question-asking skills. As they become familiar with the nuances of crafting prompts, operators can formulate more precise and context-rich queries. This, in turn, may lead to AI-generated responses that are more relevant and tailored to the operator's needs.

In some cases, when users interact with the chatbot, the chatbot may not only provide textual responses but may also provide relevant images complement the answers generated by the LLM. Illustrative steps may include, for example:

### Step 1: Convert PDFs and/or Other Documents to Image Files

The illustrative process begins with the conversion of technical document PDF pages and/or other documents into JPG files, a common image format. For PDF documents, this transformation may be executed using the pdfplumber library within a Python script. The technical documents may include both text and images/video. By converting the documents into images, the potential to extract valuable visual content is unlocked and a bridge is created between textual and visual information. In some cases, a technical document may be divided into a plurality of image files. For example, each page or each section of a technical document may be provided in its own image file (e.g. JPG file).

### Step 2: Upload Images to Azure Blob Storage

The newly created image files may be uploaded to Azure blob storage, a cloud-based storage solution. During this phase, the system captures the image URLs generated because of the upload process. These URLs serve as direct references (e.g. links) to the stored images and may be used for seamless retrieval and display with the response provided by the LLM in the chatbot.

### Step 3: Extract Text From Image Files

To make the visual content accessible and searchable, the system may employ the pdfplumber library once again. This time, it may focus on extracting text from the image files. This transformative step enables the conversion of visual data into machine-readable text, further enriching the knowledge repository. In some cases, an LLM may process each image and extract metadata that identifies objects, distance between objects, activity of the objects, and other features in the image further enriching the knowledge repository.

### Step 4: Store Image Text and URLs as Embeddings in the Vector Store

The extracted image text (and/or metadata) is seamlessly paired with the corresponding image URLs and transformed into embeddings. These embeddings, rich in contextual information, are stored in a dedicated vector store under Azure Cognitive Search platform, creating an agile and responsive knowledge repository.

### Step 5: Utilize Image Text & Links in Knowledge Base

When a user presents a query to the chatbot, the LLM may access a knowledge base that includes the image text and corresponding URLs. The knowledge base acts as a repository that not only contains textual information but also references image URLs associated with the content. The system analyzes the user's query and compares it to the textual content within the images. Using advanced similarity algorithms, the top “N” image URLs are identified that bear the most similarity to the LLM's response, where “N” is an integer greater than zero. These selected image links serve as additional resources for operators, providing visual context and supplementary information that complements the textual guidance.

In some cases, a series of steps may be carried out:
Access Interface: Operators start by accessing a user-friendly app or web UI provided by the system.
Input Query: They input their technical query or issue using natural language, describing the problem they're facing.
Langchain Orchestration: The generative AI-powered Langchain model takes over managing the process.
Azure Cognitive Search: Langchain connects with Azure Cognitive Search, which retrieves relevant documents and solutions stored as vectors. Langchain provides the relevant documents, along with the operator's query to the LLM.
AI-Generated Responses: The LLM generates contextually accurate responses to the operator's query.
Tailored Solution: Operators receive a tailored solution containing step-by-step guidance for their specific issue.
Swift Problem Solving: The intuitive interface ensures operators of all technical levels can swiftly access accurate solutions.

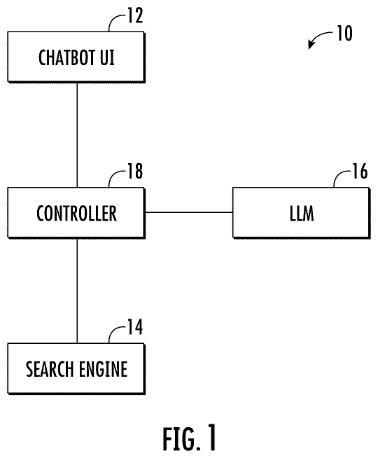

FIG. 1 is a schematic block diagram showing an illustrative system 10 for interacting with a user via a chatbot. The illustrative system 10 includes a chatbot user interface 12 for receiving a natural language query from a user. In some cases, the chatbot user interface 12 may be configured to receive natural language queries that are typed on a keyboard, or entered via a text message. In some cases, the chatbot user interface 12 may be configured to receive a verbal message from a user (e.g. via speech recognition), and to process the verbal message to obtain an alphanumeric message. In some cases, the chatbot user interface 12 may include a display and a keyboard or mouse or trackpad or other data entry device. In some cases, the chatbot user interface 12 may be manifested in a desktop computer or a laptop computer. In some cases, the chatbot user interface 12 may be manifested in a portable device such as a tablet or a smartphone, or even smart glasses or virtual reality goggles. The system 10 includes a search engine 14 and a Large Language Model (LLM) 16. The search engine 14 is configured to identify relevant information for use in formulating a response. The LLM 16 is configured to generate a response to the natural language query. A controller 18 is operatively coupled to the chatbot user interface 12, the search engine 14, and to the LLM 16.

In some cases, the controller 18 is configured to process the natural language query to formulate a corresponding search query and to submit the corresponding search query to the search engine 14. The search engine 14 identifies relevant domain specific information for use in formulating a response to the natural language query. The controller 18 is configured to submit the identified relevant information along with the natural language query to the LLM 16. The LLM 16 generates the response to the natural language query based at least in part on the natural language query and the identified relevant information that was submitted to the LLM 16. The controller 18 is configured to display the response to the user via the chatbot user interface 12.

In some cases, the relevant information identified by the search engine may include textual information and one or more relevant images or links to one or more relevant images. As an example, the response may include textual information and one or more relevant images or links to one or more relevant images. The relevant images may correspond to still images, video frames and/or videos. In some cases, the search engine 14 may be configured to compare a numerical vector representation of the natural language query to numerical vector representations of textual information and/or images of one or more of documents to identify the relevant information.

In some cases, the search engine 14 may be configured to cluster the identified relevant information into two or more clusters, depending on the search results. When this occurs, the controller 18 may be configured to provide two or more selectable options via the chatbot user interface 12 that are based at least in part on the two or more clusters, A selection of one of the two or more selectable options may be received from the user via the chatbot user interface 12. The controller 18 may be configured to submit the natural language query and at least some of the identified relevant information that is relevant to the selected one of the two or more selectable options to the LLM 16. In some cases, the LLM 16 may generate the response to the natural language query based at least in part on the natural language query and at least some of the identified relevant information that is relevant to the selected one of the two or more selectable options.

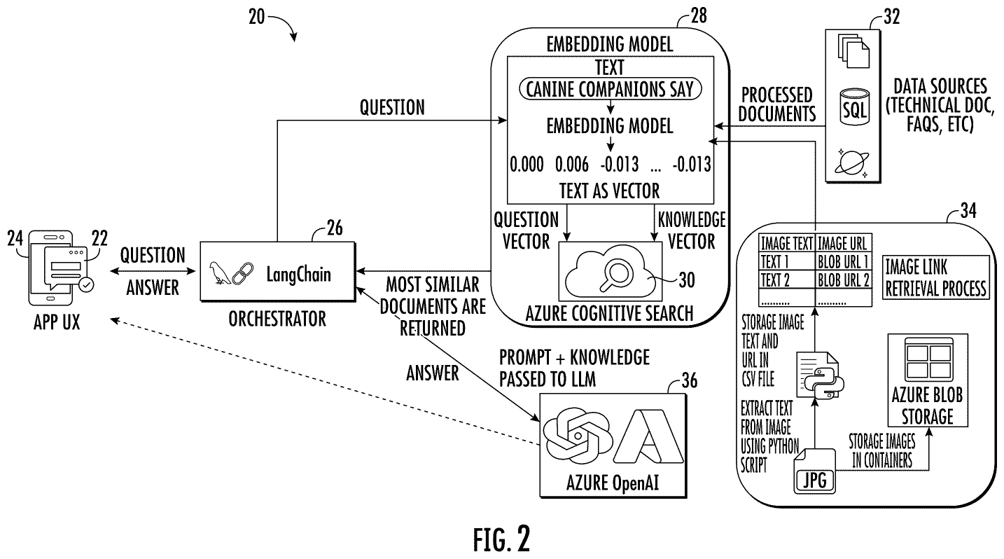

FIG. 2 is a schematic block diagram showing an illustrative architecture 20. More specifically, the architecture 20 shows how a user poses a natural language query to a chatbot, and how that query is then processed to understand the query, obtain the appropriate information for answering the query, and prepare and present a natural language answer to the user's query in a chatbot fashion. In this example, the process begins when a user inputs a query or request to the chatbot via a user interface 22 running on a computing device 24 such as a mobile device (e.g. smart phone, tablet, laptop). In this example, the query is submitted to a Langchain agent 26. The Langchain agent 26, a component of the illustrative chatbot, analyzes the query. The Langchain agent 26's role includes identifying the most suitable data sources needed to collect information from external sources to aid in formulating a response to the query. The Langchain agent 26 may help gather information from databases, APIs, file systems, real time streaming services (e.g. Kafka), and other data sources.

The Langchain agent 26 submits the query (e.g. question) to an Embedding Model 28. In some cases, and merely as an example, the Embedding Model 28 may include an Azure Cognitive Search 30 engine. In some cases, the Embedding Model 28 may be considered as being an example of the search engine 14 referenced in FIG. 1. The Azure Cognitive Search 30 is queried via question vectors against knowledge vectors, looking for similarities. The Embedding Model 28 receives processed documents from a variety of different data sources 32 such as technical documentation (such as installation guides, troubleshooting manuals, etc.), real-time operational data, databases containing customer queries (e.g. tickets) and corresponding resolutions, etc. In some cases, the Embedding Model 28 also receives relevant images from an Image Link Retrieval Process 34. The documents/information most similar to the query are returned to the Langchain agent 26. The Langchain agent 26 also communicates with an Azure OpenAI LLM 36. The Langchain agent 26 provides the original query and the most similar documents/information returned by the Azure Cognitive Search engine 30 to the Azure OpenAI LLM 36. The Azure OpenAI LLM 36 returns an answer to the Langchain agent 26, which passes the answer to the chatbot UX 22. In some cases, the Azure OpenAI LLM 36 may communicate the answer directly to the chatbot UX 22.

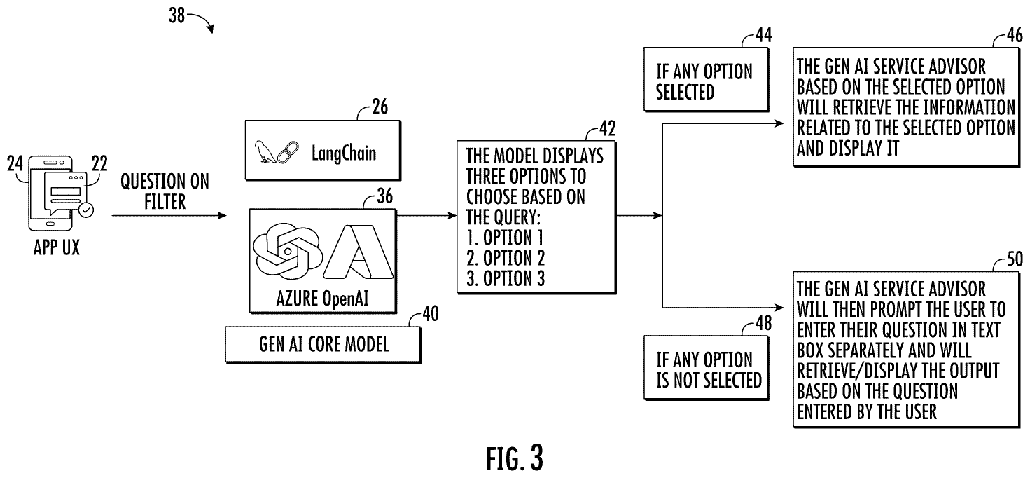

FIG. 3 is a schematic block diagram showing an illustrative prompt engineering architecture 38. A query is posed via the user interface 22 of the mobile device 24. The query is passed to a GEN AI CORE MODEL 40, which may be considered as including the Langchain agent 26 and the Azure OpenAI LLM 36. In some cases, the retrieved textual information may undergo a “similarity search” via the Azure Cognitive Search engine 30 in which the retrieved textual information is analyzed to identify similarities with the user query. In some cases, this analysis may include techniques such as natural language processing and semantic analysis to determine the relevance of each piece of textual content. The textual results may be grouped or clustered based on their similarity with each other to ensure related information is grouped together effectively. In some cases, this clustering process enhances the coherence of options generated for the user. Based on the clustered results, the system generates options for the user to choose from, as indicated at block 42. In some cases, each option represents a distinct cluster or category of information related to the user query, providing the user with a comprehensive set of choices.

The generated options are presented to the user through the chatbot interface 22, allowing them to select the option that best matches their query or interests. Once selected, the chatbot can retrieve detailed information related to that option, providing further assistance to the user. For example, once the user chooses an option, as indicated at block 44, the Langchain agent 26 prompts the Embedding Model 28 including the Azure Cognitive Search 30 to retrieve the related information from the database based on semantic similarity search and once it retrieves the required information based on the user's selected option, the Langchain agent 26 submits the original user query, the selected option and the related information retrieved from the database to the Azure OpenAI LLM 36, which generates a response, as indicated at block 46. The response is then displayed in the chatbot. If the user opts out of the option selection, as indicated at block 48, and goes on to write a custom query, the model accepts it and based on the custom query, it goes back to the knowledge base to retrieve the information and route it back to Azure OpenAI LLM 36 to generate an appropriate response for display in the chatbot, as indicated at block 50.

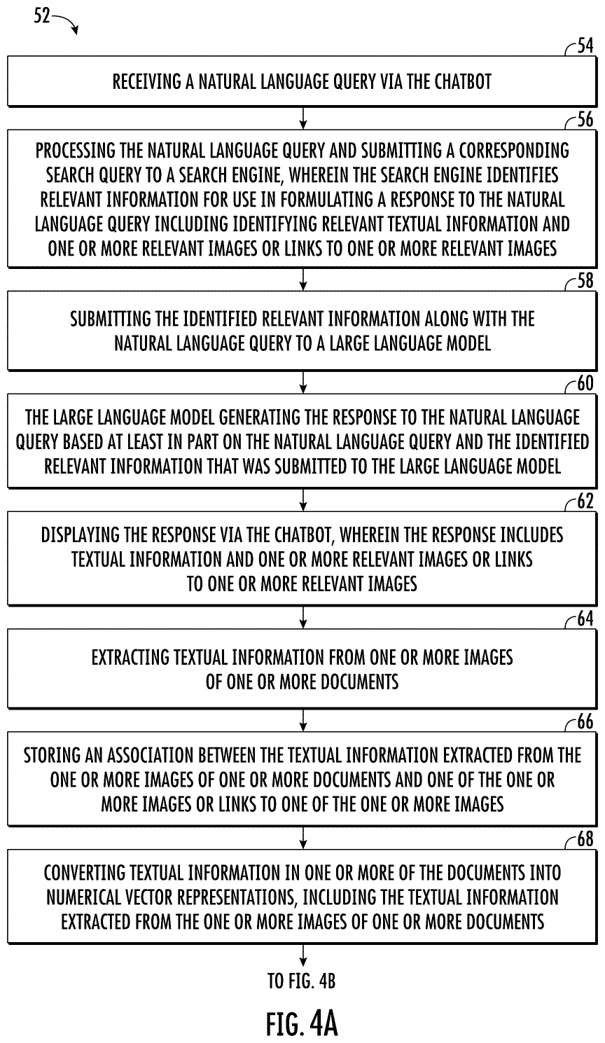

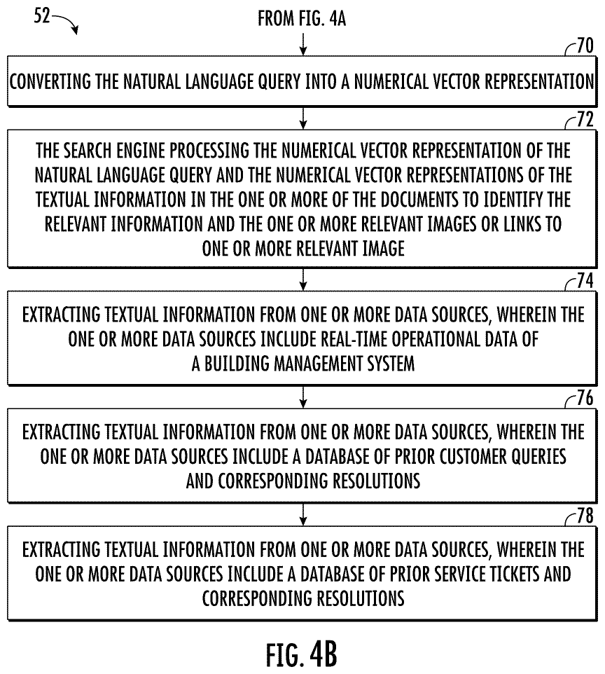

FIGS. 4A and 4B are flow diagrams that together show an illustrative method 52 for interacting with a user via a chatbot. The illustrative method 52 includes receiving a natural language query via the chatbot, as indicated at block 54. The natural language query is processed and a corresponding search query is submitted to the search engine 14, wherein the search engine 14 identifies relevant information for use in formulating a response to the natural language query including identifying relevant textual information and one or more relevant images or links to one or more relevant images, as indicated at block 56. In some cases, an orchestrator (e.g. Langchain) is configured to process the natural language query and submit the corresponding search query to the search engine 14. The identified relevant information is submitted along with the natural language query to an LLM, as indicated at block 58. The LLM generates the response to the natural language query based at least in part on the natural language query and the identified relevant information that was submitted to the Large Language Model, as indicated at block 60. The response is displayed via the chatbot, such as via the chatbot user interface 22 running on the mobile device 24, wherein the response includes textual information and one or more relevant images or links to one or more relevant images, as indicated at block 62. In some cases, one or more of the relevant images may correspond to a page or section of a document that is in an image format. In some cases, one or more of the relevant images may correspond to a particular image on a page of a document. In some cases, one or more of the relevant images may correspond to a video and/or to one or more frames of a video.

In some cases, the method 52 may further include extracting textual information from one or more images of one or more documents, as indicated at block 64. An association between the textual information extracted from the one or more images of one or more documents and one of the one or more images or links to one of the one or more images may be stored, as indicated at block 66. In some cases, the method 52 may include converting textual information in one or more of the documents into numerical vector representations, including the textual information extracted from the one or more images of one or more documents, as indicated at block 68. Continuing on FIG. 4B, the method 52 may include converting the natural language query into a numerical vector representation, as indicated at block 70. The search engine 14 processes the numerical vector representation of the natural language query and the numerical vector representations of the textual information in the one or more of the documents to identify the relevant information and the one or more relevant images or links to one or more relevant image, as indicated at block 72.

In some cases, the method 52 may include extracting textual information from one or more data sources, wherein the one or more data sources include real-time operational data of, for example, a building management system, as indicated at block 74. The method 52 may further include extracting textual information from one or more data sources, wherein the one or more data sources include a database of prior customer queries and corresponding resolutions, as indicated at block 76. In some cases, the method 52 may include extracting textual information from one or more data sources, wherein the one or more data sources include a database of prior service tickets and corresponding resolutions, as indicated at block 78. These are just example data sources.

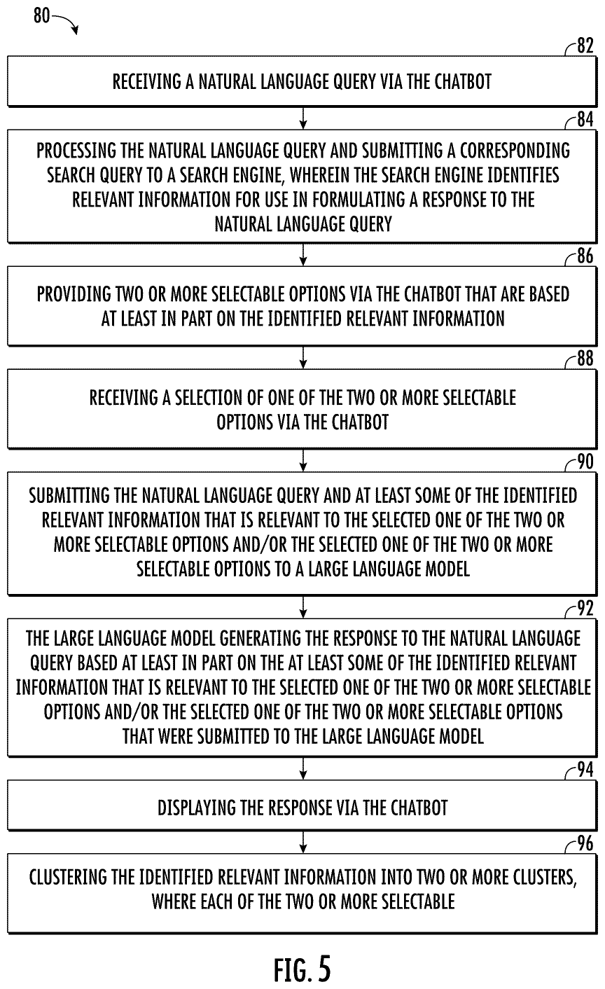

FIG. 5 is a flow diagram showing an illustrative method 80 for interacting with a user via a chatbot. The illustrative method 80 includes receiving a natural language query via the chatbot, as indicated at block 82. The natural language query is processed and a corresponding search query is submitted to the search engine 14, wherein the search engine 14 identifies relevant information for use in formulating a response to the natural language query, as indicated at block 84. Two or more selectable options are provided via the chatbot that are based at least in part on the identified relevant information, as indicated at block 86. A selection of one of the two or more selectable options is received via the chatbot, as indicated at block 88. The natural language query and at least some of the identified relevant information that is relevant to the selected one of the two or more selectable options and/or the selected one of the two or more selectable options are submitted to the LLM 16, as indicated at block 90. The LLM 16 generates the response to the natural language query based at least in part on the at least some of the identified relevant information that is relevant to the selected one of the two or more selectable options and/or the selected one of the two or more selectable options that were submitted to the Large Language Model, as indicated at block 92. The response is displayed via the chatbot, as indicated at block 94.

In some cases, the method 80 may include clustering the identified relevant information into two or more clusters depending on the search results, where each of the two or more selectable options correspond to a corresponding one of the two or more clusters, as indicated at block 96. In some cases, the two or more selectable options may correspond to the two or more clusters that the search engine identifies as having a highest correlation with the search query. In some cases, each of two or more of the selectable options may include a stated refinement to the natural language query. In some cases, one of the two or more selectable options may correspond to a request for further refinement of the natural language query by the user via the chatbot.

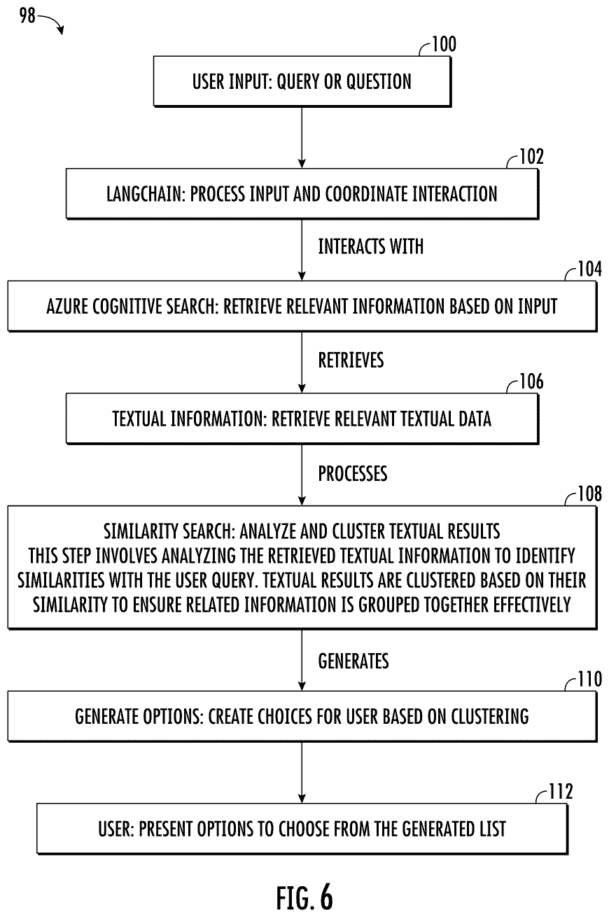

FIG. 6 is a flow diagram showing an illustrative method 98. The illustrative method 98 includes a user providing a query or question, as indicated at block 100. A LangChain orchestrator processes the input, as indicated at block 102. An Azure Cognitive search is performed, as indicated at block 104. Relevant textual data is retrieved, as indicated at block 106. A similarity search is performed, as indicated at block 108. Options are generated, as indicated at block 110. The user is presented with options to choose from, as indicated at block 112.

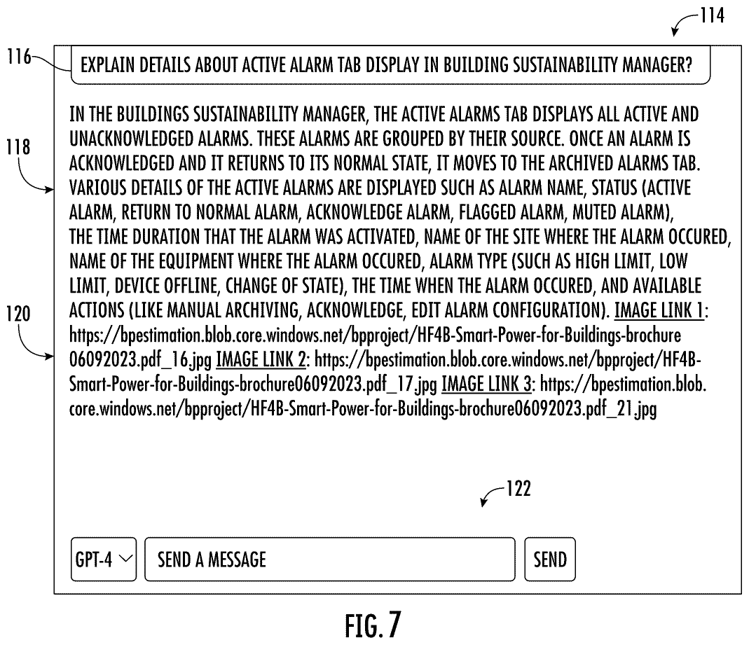

FIGS. 7 through 12 are screen captures showing example interactions with a chatbot. FIG. 7 shows a screen 114 that may be displayed on the chatbot user interface 12 (FIG. 1). The screen 114 includes a section 116 that provides or summarizes the query that was asked by the user. In this example, the user asked about an active alarm tab of a building management system of a facility. The screen 114 includes a section 118 that provides textual information. In some cases, the section 118 may include one or more image links 120 that include relevant information. The user can view one or more of these related images by clicking on the appropriate image link 120. These image links may include images from a technical document, or even a video clip that helps to answer their initial query. In some cases, an image may be displayed within the text region 114, rather than merely displaying a hyperlink. The screen 114 includes a query box 122 that the user may utilize to type in a follow-up query, for example.

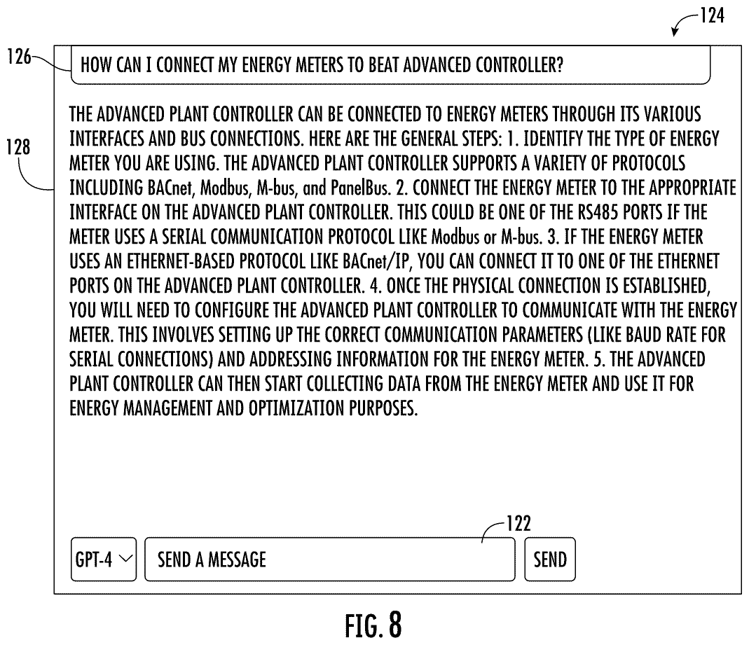

FIG. 8 shows an illustrative screen 124 that may be displayed on the chatbot user interface 12 (FIG. 1). The screen 124 includes a section 126 that provides or summarizes the query that was asked by the user. In this example, the user asked how to connect an energy meter. The screen 124 includes a section 128 that provides information. The answer provides several detailed steps for the user to follow. The screen 124 includes the query box 122 that the user may utilize to type in a follow-up query, for example.

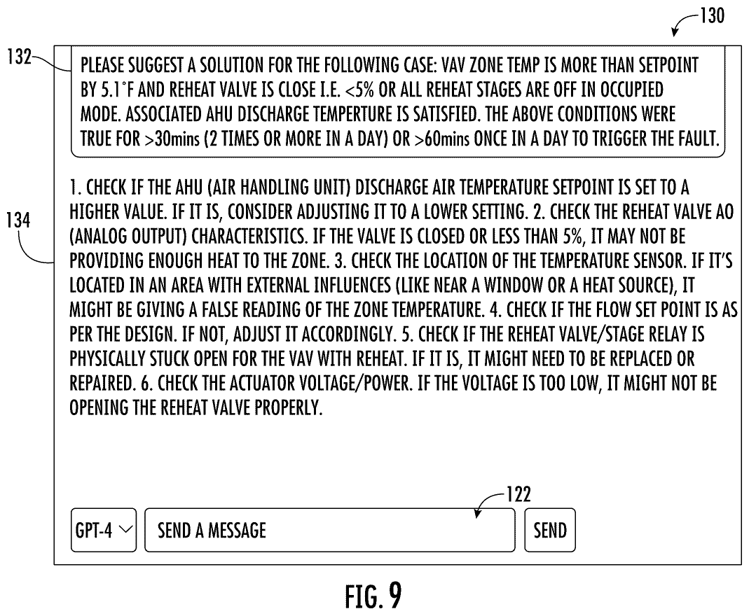

FIG. 9 shows an illustrative screen 130 that may be displayed on the chatbot user interface 12 (FIG. 1). The screen 130 includes a section 132 that provides or summarizes the query that was asked by the user. In this example, the user has asked for a solution to a particular technical problem. The screen 130 includes a section 134 that provides an answer to the query generated by the LLM. The answer provides a listing of things for the user to check on and possibly adjust. The screen 130 includes the query box 122 that the user may utilize to type in a follow-up query, for example.

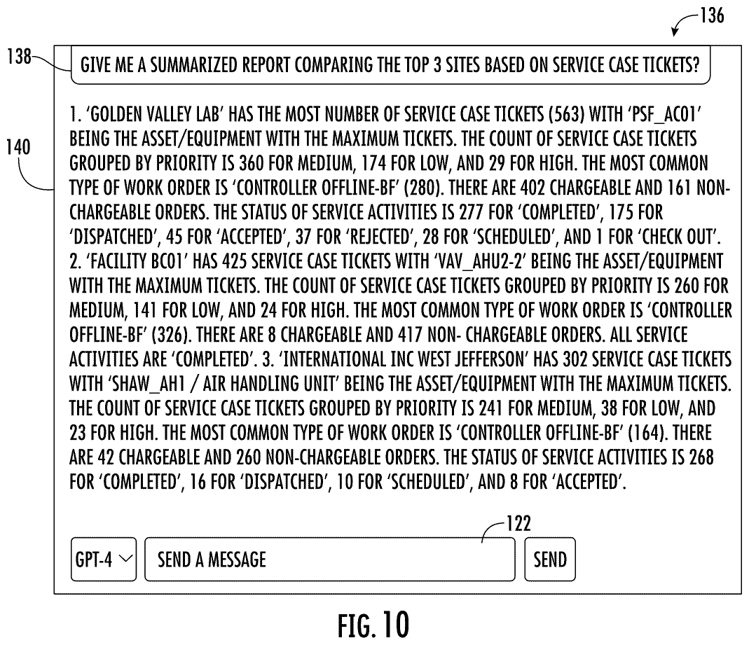

FIG. 10 shows an illustrative screen 136 that may be displayed on the chatbot user interface 12 (FIG. 1). The screen 136 includes a section 138 that provides or summarizes the query that was asked by the user. In this example, the user has asked for a summary report regarding sites with the most service case tickets. The screen 136 includes a section 140 that provides an answer to the query generated by the LLM, including supporting details. The screen 136 includes the query box 122 that the user may utilize to type in a follow-up query, for example.

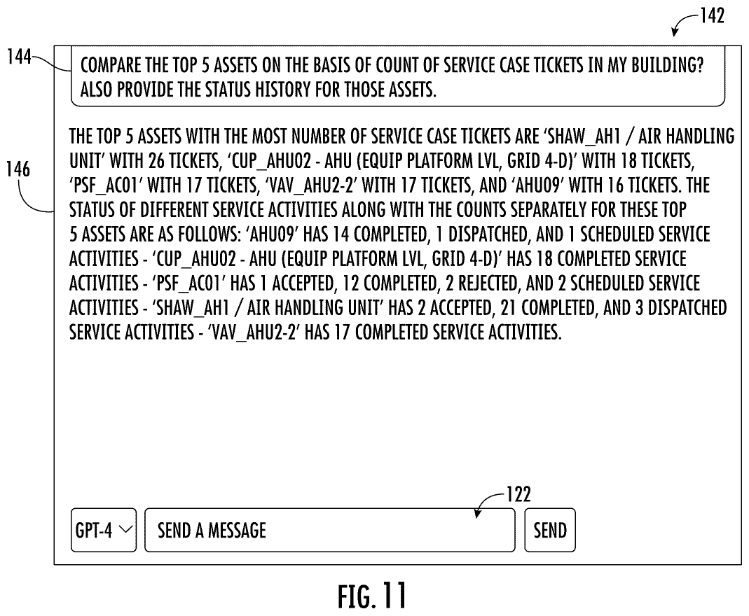

FIG. 11 shows an illustrative screen 142 that may be displayed on the chatbot user interface 12 (FIG. 1). The screen 142 includes a section 144 that provides or summarizes the query that was asked by the user. In this example, the user has asked for a comparison of assets based on service case tickets. The screen 142 includes a section 146 that provides an answer to the query generated by the LLM, including supporting details. The screen 142 includes the query box 122 that the user may utilize to type in a follow-up query, for example.

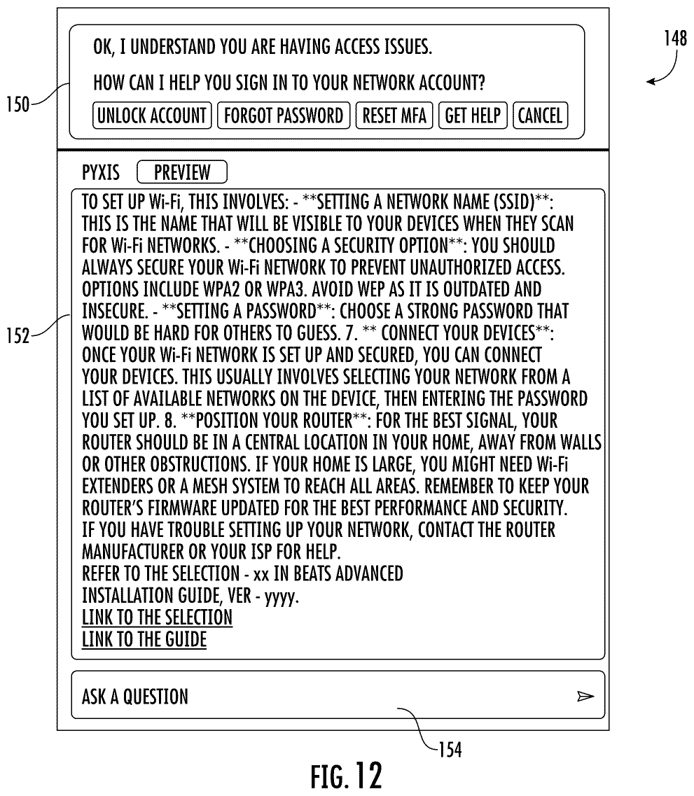

FIG. 12 shows an illustrative screen 148 that may be displayed on the chatbot user interface 12 (FIG. 10. The screen 148 includes a section 150 indicating that the system has detected that the user is having problems accessing their account. The section 150 includes several options for the user to choose from. Depending on which option the user selects, the screen 148 presents an relevant answer in region 152. The screen 148 also includes a question box 154 that may be considered similar to the query box 122 shown in FIGS. 7 through 11. In also includes links to images (“Link to the Section”, “Link to the Guide”).

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for interacting with a user via a chatbot, the method comprising:
receiving a natural language query via the chatbot;
processing the natural language query and submitting a corresponding search query to a search engine, wherein the search engine identifies relevant information for use in formulating a response to the natural language query including identifying relevant textual information and one or more relevant images or links to one or more relevant images;
submit the identified relevant information along with the natural language query to a Large Language Model;
the Large Language Model generating the response to the natural language query based at least in part on the natural language query and the identified relevant information that was submitted to the Large Language Model; and
displaying the response via the chatbot, wherein the response includes textual information and one or more relevant images or links to one or more relevant images.

2. The method of claim 1, wherein an orchestrator is configured to process the natural language query and submit a corresponding search query to the search engine.

3. The method of claim 2, further comprising:
extracting textual information from one or more images of one or more documents; and
storing an association between the textual information extracted from the one or more images of one or more documents and one of the one or more images or links to one of the one or more images.

4. The method of claim 3, further comprising:
converting textual information in one or more of the documents into numerical vector representations, including the textual information extracted from the one or more images of one or more documents;
converting the natural language query into a numerical vector representation; and
the search engine processing the numerical vector representation of the natural language query and the numerical vector representations of the textual information in the one or more of the documents to identify the relevant information and the one or more relevant images or links to one or more relevant image.

5. The method of claim 1, wherein one or more of the relevant images corresponds to a page of a document that is in an image format.

6. The method of claim 1, wherein one or more of the relevant images corresponds to particular image on a page of a document.

7. The method of claim 1, wherein one or more of the relevant images corresponds to a video and/or one or more frames of the video.

8. The method of claim 1, further comprising:
extracting textual information from one or more data sources, wherein the one or more data sources include real-time operational data of a building management system.

9. The method of claim 1, further comprising:
extracting textual information from one or more data sources, wherein the one or more data sources include a database of prior customer queries and corresponding resolutions.

10. The method of claim 1, further comprising:
extracting textual information from one or more data sources, wherein the one or more data sources include a database of prior service tickets and corresponding resolutions.

11. A system for interacting with a user via a chatbot, the system comprising:
a chatbot user interface for receiving a natural language query from a user;
a search engine;
a Large Language Model;
a controller operatively coupled to the chatbot user interface, the search engine and the Large Language Model, the controller configured to:
process the natural language query to formulate a corresponding search query;
submit the corresponding search query to the search engine, wherein the search engine identifies relevant information for use in formulating a response to the natural language query;
submit the identified relevant information along with the natural language query to the Large Language Model;
the Large Language Model generating the response to the natural language query based at least in part on the natural language query and the identified relevant information that was submitted to the Large Language Model; and
displaying the response to the user via the chatbot user interface.

12. The system of claim 11, wherein the relevant information identified by the search engine includes textual information and one or more relevant images or links to one or more relevant images.

13. The system of claim 12, wherein the response includes textual information and one or more relevant images or links to one or more relevant images.

14. The system of claim 11, wherein the search engine is configured to:
compare a numerical vector representation of the natural language query to numerical vector representations of textual information and/or images of one or more of documents to identify the relevant information.

15. The system of claim 11, wherein the search engine is configured to cluster the identified relevant information into two or more clusters, and the controller is configured to:
provide two or more selectable options via the chatbot user interface that are based at least in part on the two or more clusters;
receive a selection of one of the two or more selectable options via the chatbot user interface;
submit to the Large Language Model the natural language query and at least some of the identified relevant information that is relevant to the selected one of the two or more selectable options; and
the Large Language Model generating the response to the natural language query based at least in part on the natural language query and at least some of the identified relevant information that is relevant to the selected one of the two or more selectable options.

16. A method for interacting with a user via a chatbot, the method comprising:
receiving a natural language query via the chatbot;
processing the natural language query and submitting a corresponding search query to a search engine, wherein the search engine identifies relevant information for use in formulating a response to the natural language query;
providing two or more selectable options via the chatbot that are based at least in part on the identified relevant information;
receiving a selection of one of the two or more selectable options via the chatbot;
submitting the natural language query and at least some of the identified relevant information that is relevant to the selected one of the two or more selectable options and/or the selected one of the two or more selectable options to a Large Language Model;
the Large Language Model generating the response to the natural language query based at least in part on the at least some of the identified relevant information that is relevant to the selected one of the two or more selectable options and/or the selected one of the two or more selectable options that were submitted to the Large Language Model; and
displaying the response via the chatbot.

17. The method of claim 16, further comprising:
clustering the identified relevant information into two or more clusters; and
wherein each of the two or more selectable options correspond to a corresponding one of the two or more clusters.

18. The method of claim 17, wherein the two or more selectable options correspond to the two or more clusters that the search engine identifies as having a highest correlation with the search query.

19. The method of claim 16, where each of two or more of the selectable options includes a stated refinement to the natural language query.

20. The method of claim 19, where one of the two or more selectable options correspond to a request for further refinement of the natural language query by the user via the chatbot.
